(19) United States
(12) Patent Application Publication
(10) Pub. No.: US 2014/0131644 A1
(43) Pub. Date: May 15, 2014

(54) MULTIPURPOSE PRYING TOOL

(71) Applicant: STANLEY BLACK & DECKER INC., New Britain, CT (US)

(72) Inventors: Joshua BROWN, New Haven, CT (US); Keith M. Lombardi, Avon, CT (US)

(73) Assignee: STANLEY BLACK & DECKER INC., New Britain, CT (US)

(21) Appl. No.: 13/675,472

(22) Filed: Nov. 13, 2012

(51) Int. Cl. B66F 3/00

(52) U.S. Cl. 254/131

(57) ABSTRACT

A prying tool, such as to pry open a door or window, having a forked blade on one end formed with a dimpled shoulder. The dimpled shoulder helps to prevent tools striking he shoulder from glancing off, and eliminates sharp corners to reduces stress points which cause cracking and breaking.

### FIELD OF THE INVENTION

The present invention relates to a multi-purpose prying tool, commonly referred to as a Halligan bar.

### BACKGROUND OF THE INVENTION

Prying tools are commonly used by firefighters for a variety of purposes, including breaking through doors or other entry points to enter buildings. Some of these types of tools have come to be known as Halligan bars in the firefighting industry, and are typically a long bar having a forked blade on a first end, and a solide blade and tapered pick on a second end. This tool is often carried with an axe with the set commonly referred to as “irons.”

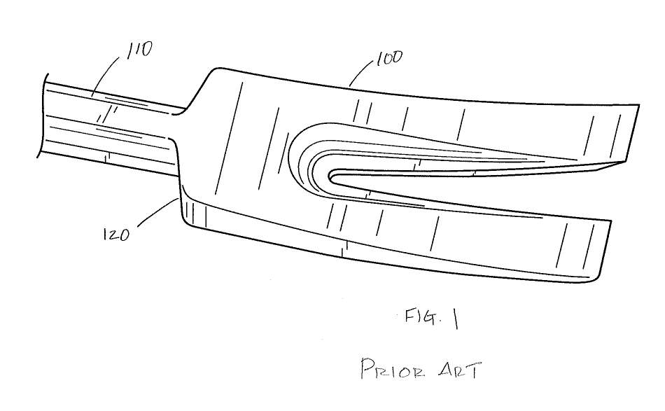

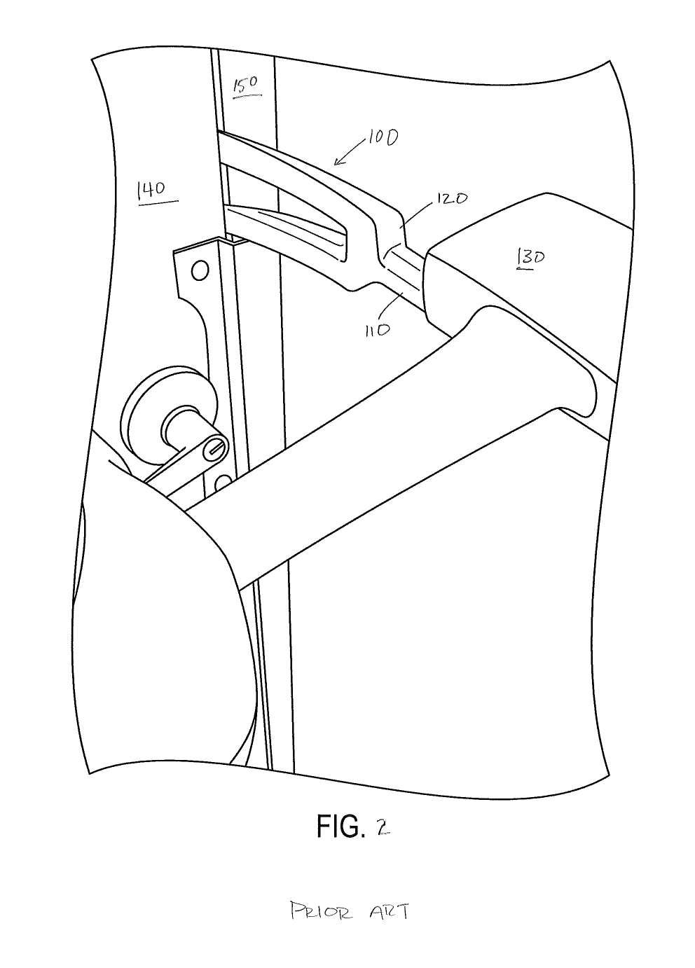

Referring to FIG. 2, when breaking through a door, it is common to force the forked end 100 of such a tool between a door 140 and door jamb 150. If needed, an axe 130 can be guided along the shaft 110 of the tool and struck against the shoulder 120 of the forked end to wedge it into position. The door 140 can then be pried loose. However, as FIG. 1 shows, the existing shoulders 120 of the forked ends are slanted away from the tool which encourages the axe to glance of the shoulder 120.

For this reason, it is known that individuals sometimes file down these shoulders to create flatter surfaces for easier striking by the axe head. However, this creates sharp corners at the shoulder that cause stress concentrations leading to cracking or fracturing of the tool.

Therefore, it would be advantageous to have a halligan bar that can be struck by an axe or other impact tool to easily wedged in between a door and door jamb.

### BRIEF SUMMARY OF THE INVENTION

In an aspect of the invention, this is accomplished by creating a dimpled shoulder on the forked end of the tool, which discourages the axe head from glancing off while maintaining the strength of the forked end.

### BRIEF DESCRIPTION OF THE INVENTION

Further features and advantages of the present invention will be better understood by reference to the following description, which is given by way of example and in association with the accompanying drawings, in which:

FIG. 1 is a view of a forked end of a prior art halligan bar;

FIG. 2 shows a halligan bar of FIG. 1 being wedged into a door;

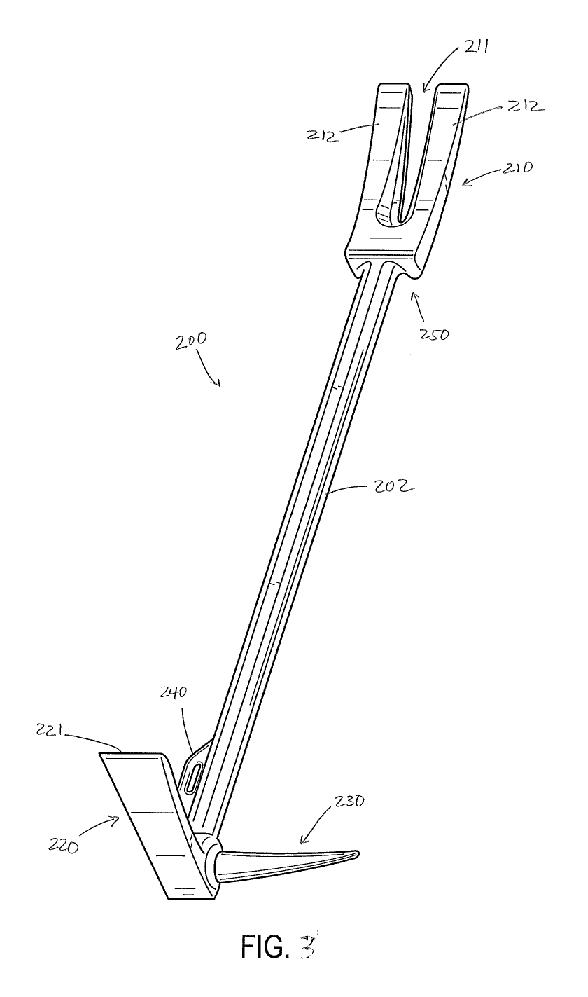

FIG. 3 is a perspective view of a halligan bar according to an embodiment of the invention;

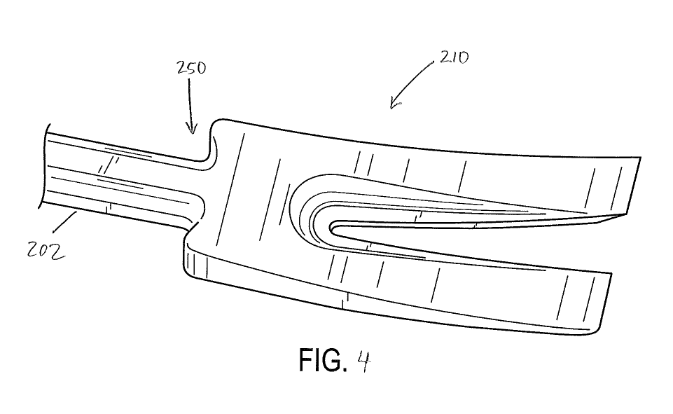

FIG. 4 is a close up view of the forked end of the bar of FIG. 3;

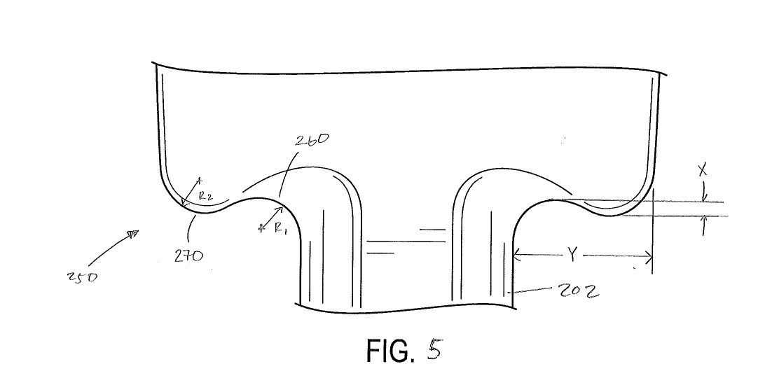

FIG. 5 is front view of the shoulder portion of the forked end of FIG. 3;

### DETAILED DESCRIPTION OF THE INVENTION

Referring to FIG. 3, a multi-purpose prying tool of the present invention, commonly known as a halligan bar, is shown. The halligan bar 200 is typically made of a forged metal having a long shaft 202 with various prying implements on its ends, such as a forked blade 210 at a first end, and a solid blade 220 and a tapered pick 230 at a second end. Also included on the shaft is a ring 240 that can be used to attach the bar to a carrying strap or otherwise secure the tool. The forked blade, solid blade and tapered pick are examples of the types of implements that can be used this invention and not meant to be exclusive.

In use, the pick 230, which is generally cone-shaped ending in a sharp point, is typically forced into a shackle (or eye) of a padlock or hasp and twisted or pried to break it free. It can also be driven into a roof to provide a foothold for firefighters engaged in vertical ventilation.

The solid blade 220 or forked blade 210 can be used to quickly pry open a door by inserting in between a door and door jamb, and prying the door loose. The solid blade 220 is formed as a generally rectangular implement with a single cutting surface 221. In contrast, the forked blade 210 includes a split 211 down its middle to form two smaller blades 212, and has other uses, such as to shut of gas meter valves.

Additionally, the fork 210 has shoulders 250 (see FIG. 5) with a curved dimple 260, which forms the inside depression. This dimple 260 has a first radius R1, which should be as large as possible to help aid material flow during the forging process, which in the preferred embodiment is approximately 5 mm. This dimple 260 naturally forms an adjacent outer protrusion 270, which has a second radius R2, which in the preferred embodiment, is also approximately 5 mm. The combination of R1 and R2 provide a shoulder depth of X, which in the preferred embodiment is approximately 2 mm. The combination of R1 and R2 also contribute to the width Y between the shaft 202 and the outer edge of the forked 210. This width Y should be large enough to ensure that the striking tool firmly impacts the interior portion of the protrusion 270 (rather than the outer surface which would force the striking tool to glance off), but not so large as to allow the striking tool to impact the dimple 260. In the preferred embodiment, the width is approximately 16 mm.

The protrusion 270 and dimple 260 are formed with smooth curves so that no sharp corners exist, which prevents stress concentrations from forming. Sharp corners lead to high stress values in localized areas, and after repeated impact from a striking tool, the material at the root of the corner becomes overstressed and can crack. This is important since users will often use an axe or other striking tool to strike the shoulder 250 of the forked end to wedge it further into prying position.

The present invention thus improves upon prior art devices, which have flat sloping surfaces that tend to encourage the striking tool to glance off the shoulder. The dimpled shoulder of the present invention discourages this glancing effect, since only a small portion of the protrusion 270 faces away from the shaft 202 (eg. the outwardly facing portion of the protrusion 270).

While the invention has been described in the specification and illustrated in the drawings with reference to a preferred embodiment, it will be understood by those skilled in the art that various changes may be made and equivalents may be substituted for elements thereof without departing from the scope of the invention as defined in the claims. In addition, many modifications may be made to adapt a particular situation or material to the teachings of the invention without departing from the essential scope thereof. For example, one or more of the pick, blade, or fork can be replaced with other types of cutting or breaking elements in any variety of combination thereof. Therefore, it is intended that the invention not be limited to the particular embodiment illustrated by the drawings and described in the specification, but that the invention will include any embodiments falling within the description of the appended claims.

1. A prying tool comprising:
a shaft having a first end and a second end;
a first prying implement on a first end and a second prying implement on a second end;
wherein at least one of the prying implements having shoulders extending generally perpendicular from the shaft;
the shoulder having a dimple forming a depression and a protrusion formed with smooth curves, whereby the depression is located in between the shaft and the protrusion.

2. The prying tool of claim 1, wherein the prying tool is forged.

3. They prying tool of claim 1, wherein the at least one of the prying implements is a forked blade.

4. The prying tool of claim 1 wherein the depression and the protrusion have approximately the same radius and the width of the shoulder is greater than 10 mm.

5. A prying tool comprising:
a shaft having a longitudinal axis and a first end and a second end;
a first prying implement on a first end having a smoothly formed dimpled shoulder adapted to receive the impact of a striking tool, wherein the dimpled shoulder forms a depression and a protrusion, and the peak of the protrusion extends upward in a direction parallel to the longitudinal axis from the depression so that a tool striking the shoulder will strike the protrusion.

6. The prying tool of claim 4, wherein the prying tool is forged.

7. A prying tool comprising:
a shaft having a first end and a second end, a longitudinal axis extending from the first end to the second end;
a first prying implement on the first end having a pair of shoulders extending outwardly from the longitudinal axis, the shoulder having a dimple forming a protrusion, the protrusion extending upwardly in the direction of the second end.

8. The prying tool of claim 7, wherein the second end of the shaft includes a second and third prying implement.

9. The prying tool of claim 8, wherein the prying tool is made of a forged metal.

10. The prying tool of claim 9, wherein the dimple has smooth curves.

11. The prying tool of claim 10, wherein the dimple is generally circular shaped with a radius of approximately 5 mm.
